(19) United States
(12) Patent Application Publication
(10) Pub. No.: US 2025/0065808 A1
(43) Pub. Date: Feb. 27, 2025

(54) Boat trailer ladder with auto-close mechanism and side extension

(71) Applicant: Bow Step, LLC, Shafer, MN (US)

(72) Inventors: Mark Ebbenga, Shafer, MN (US); Mei-Yun Lee, Taoyuan City (TW)

(21) Appl. No.: 18/812,683

(22) Filed: Aug. 22, 2024

Related U.S. Application Data
(60) Provisional application No. 63/534,247, filed on Aug. 23, 2023.
(60) Provisional application No. 63/541,487, filed on Sep. 29, 2023.
(60) Provisional application No. 63/564,901, filed on Mar. 13, 2024.

(51) Int. Cl. B60R 3/02; B60P 3/10

(52) U.S. Cl. CPC B60R 3/02; B60P 3/10

(57) ABSTRACT

A ladder assembly for mounting to a boat trailer comprising a stationary ladder section with a plurality of steps and a stair extension portion comprising one or more steps. The stair extension portion is rotatably coupled to the stationary ladder section and a mechanism for actuation of automatic rotation of the stair extension portion for deploying and/or stowing the stair extension with respect to the stationary ladder section is provided at an upper end of the ladder assembly so that the ladder extension can be stowed when a user is at or near the top of the ladder. A boat trailer mounting assembly couples the ladder assembly to the boat trailer and a stair extension rotation control mechanism controls at least one of a speed and actuation of deploying or stowing of the stair extension portion.

### BACKGROUND

The present disclosure relates to an apparatus used for a person's entry onto the bow of a boat or descent from a bow of a boat as the boat rests on a trailer, truck bed, or other support surface. When a boat is on a trailer, the boat is held higher off the ground, making entry difficult. Further, when a boat trailer is entering the water, the apparatus facilitates the person's entry onto the boat or descent from the boat without the person getting wet.

When a boat is being launched and the boat and trailer are backed into water, accessibility to the boat is restricted and usually not very easy to accomplish, especially when there is no dock. Boarding ladders of the type commonly provided with boats are typically designed for access from the water and thus may be located too high for convenient access to a boat on a trailer.

When launching the boat, the trailer and boat are generally towed by a vehicle such as a truck or SUV. When backing the trailer into the water, navigating from the driver's seat frequently results in maneuvers such as turns while backing the trailer down a boat launch and into the water. Such turns frequently result in smashing the rear bumper of the trailer into one or more parts of a trailer mounted entry ladder if, for example, the ladder is inadvertently left in an open position during launch. This results in bumper damage, which can be expensive to fix as many vehicle bumpers now include expensive wiring and sensors for rear cameras and other object and/or lane detection sensors.

### SUMMARY

An aspect of the present disclosure relates to a ladder for mounting to a boat trailer comprising a stationary ladder section comprising a plurality of steps; and a stair extension portion comprising one or more steps, wherein the stair extension portion is rotatably coupled to the stationary ladder section; a mechanism for actuation of automatic rotation of the stair extension portion for deploying and/or stowing the stair extension with respect to the stationary ladder section; a boat trailer mounting assembly for coupling the ladder assembly to the boat trailer; and a stair extension rotation control mechanism for controlling at least one of a speed and actuation of deploying or stowing of the stair extension portion.

The ladder assembly is moveable between a first position wherein the stair extension is deployed for use and a second position wherein the stair extension is stowed and when stowed the stair extension does not obstruct an entrance to the stationary ladder section.

In the first position the stair extension is deployed and is positioned below and to a side of the stationary ladder section.

The mechanism for actuation of automatic rotation of the stair extension portion is provided on an upper portion of the stationary ladder section accessible from both a position on the ladder assembly and off the ladder assembly.

In one or more embodiments, a second mechanism for actuation of the rotation of the stair extension portion is provided on a lower portion of the stair extension wherein the first and second mechanisms apply force to the stair extension rotation control mechanism for actuation thereof.

The stair extension rotation control mechanism comprises an air cylinder operably coupled between the stationary ladder section and the stair extension portion.

A connection bracket couples a framework of the stationary ladder section to a framework of the stair extension portion, the connection bracket stationarily secured to the framework of the stationary ladder section and the stair extension rotatably coupled to the connection bracket.

The connection bracket is also coupled to the boat trailer mounting assembly which comprises a bracket assembly that allows adjusting an angle and/or position of the ladder assembly with respect to the boat trailer when mounting the ladder assembly to the boat trailer.

In one or more embodiments, the ladder framework further comprises one or more handrails. The one or more handrails may be vertical handrails.

In one or more embodiments, the ladder assembly further comprises a lighting system for illuminating one or more steps of the assembly.

The stair extension portion comprises a support arm for supporting the at least one step and wherein the support arm comprises at least one bend along a length thereof.

In one or more embodiments, the stair extension comprises at least two steps and the at least two steps are spaced apart by the at least one bend along the length of the support arm.

Another aspect of the present disclosure relates to a method of using a ladder to enter a boat from a ground surface comprising securing a ladder assembly to a location on a boat trailer supporting the boat; releasing a ladder extension mechanism to allow a ladder extension portion of the ladder assembly to rotate downwardly away from a main ladder body of the ladder assembly to expose additional steps of the ladder extension portion for climbing the ladder assembly; and actuating the ladder extension mechanism to raise the ladder extension portion for stowing the ladder extension and providing ground clearance for moving the boat trailer without obstruction.

Positioning the ladder assembly with respect to the boat and boat trailer is done by adjusting an angular position of a mounting bracket for securing the ladder assembly to the location on the boat trailer.

The ladder extension rotates downwardly to a side of the main ladder body such steps of the ladder extension extend vertically in a first direction and steps of the main ladder body extend vertically in a second direction different from the first direction.

Releasing the ladder extension mechanism allows the ladder extension portion of the ladder to rotate downwardly away from a main ladder body, from a position located at an upper end of the ladder assembly.

Actuating the ladder extension mechanism raises the ladder extension portion from a position located at an upper end of the ladder assembly or from a position located at a lower end of the ladder assembly.

In one or more embodiments a same mechanism is located at the upper end of the ladder assembly for alternately releasing the ladder extension mechanism and actuating the ladder extension mechanism for moving the ladder extension between a deployed and a stowed position via the same mechanism.

In one or more embodiments a second, distinct mechanism is provided at the lower end of the ladder assembly for actuating the ladder extension mechanism to raise the ladder extension and wherein actuating the ladder extension comprises applying force to the second mechanism from one or more directions.

### BRIEF DESCRIPTION OF THE DRAWINGS

FIG. 1A is a front side view of an auto close boat trailer ladder with a stair extension in an extended, use position and FIG. 1B is a front side view of the ladder with the stair in a stowed position.

FIG. 2A is a side view of an auto close boat trailer ladder with a stair extension in an extended, use position and FIG. 2B is a side side view of the ladder with the stair in a stowed position.

FIG. 3A is a top perspective view of an auto close boat trailer ladder with a stair extension in an extended, use position and FIG. 3B is a top perspective view of the ladder with the stair in a stowed position.

FIG. 4A is a rear bottom perspective view of an auto close boat trailer ladder with a stair extension in an extended, use position and FIG. 4B is a rear bottom perspective view of the ladder with the stair in a stowed position.

FIG. 5A is another rear perspective view of an auto close boat trailer ladder with a stair extension in an extended, use position and FIG. 5B is another rear perspective view of the ladder with the stair in a stowed position.

FIGS. 6A-6C illustrate a ladder mounting assembly for securing the ladder to the boat trailer.

FIGS. 7A and 7B illustrate the ladder mounting assembly with alternative brackets for securing the ladder to a trailer of different sizes.

FIG. 8 is a flow chart illustrating extension and stowage of the stair extension for close of the ladder from the use to stowed position.

### DETAILED DESCRIPTION

Described herein is a mountable ladder which is a two part stair system. The ladder has a vertical stair portion and a stair extension portion which rotates outwardly and downwardly from the vertical stair to provide one or more steps at lower heights for ease of entry on to the ladder when it is mounted off a ground surface. The stair extension folds back to a position behind or on one side of the vertical stair portion, so that the vertical stair portion is not obstructed and can be accessed whether or not the stair extension portion is deployed. To deploy the extension, a handle or other actuation means or mechanism is operably secured to a position on the ladder, for example, near a top portion of the vertical stair or other easily accessible height on the ladder. Displacement of the handle deploys the stairs and can be reciprocally displaced to stow the extension behind the vertical stair portion. The extension may also be manually or automatically stowed by application of slight force to the stair extension from below the steps thereof (e.g., using a foot or hand and gently pushing the extension upwardly to trigger automatic stowing, or in the event the extension is down and bumps into a moving object or an object at rest if the trailer and stair is moving is enough to trigger retraction and stowing of the extension.)

A locking mechanism may also be provided to secure the extension in the deployed state and/or stowed state. Additionally or alternatively, gravity may aid in securing the extension in the deployed state. The actuation mechanism for stowing the stair extension may also be combined with and/or integrally formed with a locking mechanism such that as the mechanism retracts the stair extension a further turn or displacement of the locking mechanism pushes the locking mechanism over-center which secures or locks the stair extension in the stowed position.

The apparatus described herein may be used for a person's entry onto or into a boat, for example, up and on to the bow of a boat or descent from the boat or bow of the boat as the boat rests on a trailer, truck bed, or other support surface. The ladder assembly having a retractable or stowable stair extension is mountable and may be mounted to a location on a boat trailer.

In one or more embodiments, the ladder assembly comprises a main body which provides a first ladder portion to the assembly. The main body supports one or more steps supported on a frame or other stair support of the main body. Rotatably or pivotally coupled to the main body is a second ladder portion, comprising a stair extension. The stair extension comprises an extension frame or other extension stair support which supports one or more steps. The ladder assembly can be used for climbing when the stair extension is deployed as well as when the stair extension is stowed. The stair extension in a stowed position is provided in a folded position such that the stair extension does not obstruct the steps of the first ladder portion. When the ladder assembly is mounted to a boat trailer, the stowed stair extension similarly does not obstruct access to the boat, trailer, nor reside in a travel path of a towing vehicle connected to the trailer as the vehicle may turn with respect to the trailer.

When the stair extension is deployed or extended from the main body of the ladder assembly, the ladder assembly provides an increased overall vertical ladder height. The stair extension deploys downwardly and outwardly to a side location proximate and/or adjacent the main body. For example, the stair assembly may be deployed for use in a position below the first ladder portion and to a side thereof such that a user climbs the stair extension in a first vertical direction and turns to continue climbing the ladder of the main body in a second vertical direction different from the first vertical direction. Although it is contemplated and within the scope of this disclosure that the stair extension may deploy to a location directly in front of the main body of the ladder assembly or offset therefrom such that climbing and descending the ladder assembly is completed without any turns.

In one or more embodiments, when stowed, the stair extension is rotated upwardly and behind the first ladder portion. Deploying and stowing of the stair extension can be done automatically by way of actuation of a mechanism for deploying and stowing the stair extension that is location at or near an upper end of the ladder assembly, for example at or near a top step or upper platform of the ladder assembly. An additional mechanism for stowing and/or deploying the stair extension may also be provided at a lower end of the ladder assembly, for example, at or near a bottom step of the stair extension.

The mechanism for deploying and stowing the stair extension as provided at the upper end of the ladder assembly may include a lever or handle that is actuatable by a user's foot when the user reaches the top of the ladder assembly to automatically stow the stair extension as the user is at the top of the ladder assembly. This mechanism is also operable and can be reached from a user inside the boat such that the user may stow the stair extension by actuation of the mechanism from inside the boat and similarly deploy the stair extension from inside the boat and/or when at the top or on the upper section of the ladder assembly.

The optional additional mechanism for stowing and/or deploying the stair extension provided on the stair extension includes a foot pad or the like which can be force actuated to effect retraction of the stair extension. For example, force applied to the foot pad from any direction may then actuation the process of stowing the stair extension. In such embodiments, the foot pad extends downwardly from the frame or support of the stair extension and thus is provided below and behind the bottom step of the stair extension. Thus, a user on the ground may be able to tap or kick the foot pad to stow the stair extension and more importantly, if the user forgets to stow the stair extension before travel, if the tow vehicle turns tightly or travels over a bump, the stair extension will automatically be stowed preventing damage to the stair extension and ladder assembly.

In one or more embodiments the ladder assembly is secured to a location on a boat trailer to provide access to the inside of the boat carried by the trailer. One or more brackets are used to secure the ladder assembly to the trailer. For example, a bracket system is used to secure the main body of the ladder assembly to the boat trailer. The bracket system is also adjustable, allowing a user to select not only the location but the orientation (e.g., angle) of the main body ladder portion with respect to the trailer. When coupled to a trailer, the main body of the ladder assembly is stationarily secured thereto and the stair extension rotatably secured to the main body. The bracket system is also adjustable such that the ladder assembly can be mounted to various style and size trailers.

The ladder assembly may be mounted to any location on a boat trailer, including but not limited to the side frame or the winch stand. The mounting assembly for the ladder assembly is adjustable and allows the ladder assembly to mounted on the port or starboard side of the boat with respect to the boat trailer, and in one or more embodiments, ladder assemblies may be mounted on both the port and star board sides on the boat trailer.

The ladder assembly may further be provided with and/or usable with a boat loading sensor system. The boat loading sensor system comprises one or more sensors such as position and/or distance sensors, optical sensors, ultrasonic sensors or combinations thereof and in communication with one or more indicators such as visual or audial indicators or combinations thereof. The sensor system may be used to provide continuous feedback as to the location of a boat being loaded onto the trailer. As such, the sensor system can be mounted to the ladder assembly, the trailer, or in proximately thereto. The sensors are in communication with one or more visual or audial indicators to direct a user as to the location of the boat entering the trailer. For example, the sensor system is provided with lights that emit green or red depending on the location of the boat entering the trailer and change in response to a signal from the sensor indicating the boat is centered or offset to one side to provide a real time indicator to change the direction of loading of the boat onto the trailer. Other uses for the sensor system are contemplated and within the scope of the disclosure. In one embodiment, the sensor system is mounted to or integral with the ladder assembly and visual indicators in the form of lights are mounted to the hand rail(s) of the ladder assembly which are adjustable and may extend to a location above the bow of the boat. Thus, two sensors are provided on opposing sides of the boat trailer and thus bow of the boat, for example, at locations equidistant from the boat as being located on opposing sides of the trailer equidistant from center of the trailer or otherwise squarely on either side of the location of the boat on the trailer. The sensor system provides real time, continuous feedback as to the position of the boat being loaded onto the trailer.

When the ladder assembly is secured to the trailer, the stair extension extends downwardly from a location at or near the mounting location of the ladder assembly to the trailer. Thus, at least one of the one or more steps of the stair extension are deployed at or below a height approximately level with the trailer and/or mounting location. In some embodiments, a lower step of the stair extension is deployed below a height if the trailer mounting location, providing a step that may be as low as approximately 7-8 inches off a ground surface. Thus, the stair extension provides steps closer to the ground than the trailer mounting location, allowing for a lower entry point and easier access onto the ladder assembly. Moreover, the stair extension extends to a side of the main body of the ladder assembly, allowing a user to access the ladder assembly from an open space outside of the boat and away from the trailer while being able to climb up the ladder assembly to a location near the boat for easy entry up and into the boat itself.

The stair extension further provides steps that swing to a side of the main body and the first ladder portion such that both the first ladder portion and the second ladder portion have steps that together provide a multi-directional ladder assembly.

One or more handles or handrails may be provided to the ladder assembly. The orientation of the first and second ladder portions with respect to one another allows for a handle or handrail to be centrally located for ease of use as a user enters the ladder via the stair extension and turns in direction of climbing when entering the first ladder portion. The handle may extension upwardly from the ladder assembly such that the steps are open for access with a handle that can be gripped and used when a user is on both the first ladder portion of the main body and the second ladder portion of the stair extension. A second handle may be provided at or near the top of the ladder for aiding a user in boat entry and exit.

The deploying and stowing of the stair extension with respect to the main body of the ladder assembly may be considered automatic and/or controlled. At least one mechanism for automatically controlling the deploying and stowing of the stair extension is integrated into the ladder assembly. The actuation mechanism on or adjacent a top or upper step of the first ladder portion of the ladder assembly is moveable between two positions, a first position activates and/or allows stowing of the stair extension and when moved to a second position activates and/or allows for deploying of the stair extension. This actuation mechanism may be a lever having dimensions and a position adjacent a top or upper step of the ladder assembly such that when a user reaches the top of the ladder assembly they can use their foot to stow the stair extension when exiting the ladder and entering the boat or using their foot to move the lever to the second position when in the boat or at the top of the ladder assembly to deploy the stair extension for using the extended ladder assembly to exit the boat. A surface of the lever is also configured for using a hand from inside or outside of the boat to actuate movement of the lever between the first and second positions.

In one or more embodiments, controlling the extension and retraction of the extending framework is an air cylinder, gas shock, pneumatic cylinder, or a similar actuator which provides for reciprocal, controlled linear movement. The cylinder controls the deploying and stowing speeds of the stair extension and/or supports the stowing and/or deploying action. The gas shock may also be replaced by an electric module allowing the ladder assembly to be remotely controlled for deployment of the stair extension and stowing thereof.

The ladder assembly may also be provided with lighting along each step in the ladder assembly including one or both of the first and second ladder portions and/or along the frame or support of either or both of the first and second ladder portions. This lighting may further be activated concurrently with moving the actuation mechanism to a second position which also deploys the stair extension. The lights may be LED lights incorporated into and/or along one or more steps of the ladder assembly, along the frame and/or support of one or both of the main body and stair extension, along or at one or more locations on the handle or handrail(s) of the ladder assembly or combinations thereof. The handles may further be provided with integrated lighting, light rings or other lighting for the handles. The lights may be battery powered, with the battery secured to a location below a stair of the ladder assembly or within a handrail for example. Additionally, or alternatively the lighting may be solar powered.

Each step of the ladder assembly may have a same or different footprint dimension and the steps, each being substantially horizontally oriented for use may further be provided with a texture or other friction increasing surface for added safety. The steps of the extension are not horizontally orientated when in the stowed position and thus are not usable or accessible when in the stowed position.

When launching a boat, the trailer is backed down a ramp or launch with the boat thereon. A vehicle, referred to as a launch or launching vehicle, is generally a truck or SUV capable of towing the trailer and boat on roads. The ladder may stay secured to the boat trailer before, during and/or after launch, and in a folded, stowed, or collapsed position that does not obstruct launch of the boat or travel of the trailer. The ladder assembly need not be removed from the trailer for travel or storage.

During launch, a user may enter and exit the boat, using the ladder and forget to stow the stair extension. As the driver of the launching vehicle reverses and steers the launching vehicle, including small turns, a bumper or rear section of the vehicle may come into contact with the stair extension in the deployed position. Such contact could generally damage the bumper or other panel of the launching vehicle. However, the ladder assembly described herein may include an auto-close mechanism that causes the ladder to fully stow the stair extension when force is applied to a front or lower portion of the ladder assembly by the vehicle and/or to the stair extension, thus preventing and/or significantly reducing the possibility for damage to the launching vehicle during launch or other travel with the ladder on the boat trailer. The ladder can similarly be returned to the stowed position by way of actuation of the closure mechanism from a top of the ladder assembly.

The ladder of one or more embodiments as described herein is a step ladder generally constructed from aluminum and having a plurality of steps. The steps may be provided as extending outwardly from a central frame support or a single side rail, meaning the ladder has one leg and may be open for access on both or one side. Such a ladder is an open stair ladder. The handrail(s) is/are an optional element and may comprise a railing extending vertically from a main body of the assembly, the single side rail, a step of the ladder, or combinations thereof. The ladder may have one or more steps that are not linearly aligned, that is, the steps may be adjacent or offset from one another to provide additional access or climbing points to the ladder. For example, the stair extension may provide additional steps that are positioned to a side of the steps of the main body.

The ladder of one or more embodiments described herein is secured to a boat trailer via an arm and bracket assembly, for example, the ladder can be secured directly to a front portion of the boat trailer, such as near the bow of the boat on the trailer. In one or more embodiments, the ladder assembly comprises a combination bracket where this combination bracket receives a portion of the main body therein or is otherwise coupled to the main body in a stationary manner. The combination bracket is also provided with a mechanism for rotatably coupling the bracket to the stair extension, thus rotatable securing the main body to the stair extension. This combination bracket then may further be coupled to one or more brackets for securing the ladder assembly to the trailer or a surface thereon.

In one or more embodiments, the ladder is equipped with a mechanism for preventing damage to a towing vehicle. This mechanism may be operably connected to the closure mechanism and/or may be an independent safety closure. This safety mechanism may comprise one or more closure actuation mechanism position on the stair extension for example. The closure actuation mechanism may be a foot or bumper pad that may be secured to a lower section of the front of the ladder, or at or below the lower step of the stair extension. The safely mechanism may further comprise the foot or bumper pad extending outwardly or downwardly from the ladder towards a location near the ground surface in space where a rear bumper or side of a towing vehicle may enter that space when launching the boat on the trailer just prior to contacting the open ladder. The pad extends from the ladder and when force from a side, front, rear or otherwise a force from any direction applied to the pad, the gas shock is actuated and the stair extension is retracted for stowing. The stair extension retracts to a stowing position out of the way of the tow vehicle such that the tow vehicle may turn tightly to an acute angle with respect to the trailer being towed without hitting a properly stowed ladder assembly secured to the trailer.

The ladder assembly illustrated herein includes a two-step deployable extension and a four-step main body. However, the ladder assembly can be provided in various configurations for use with boats of different sizes. For example, the deployable stair extension may have one step or may have three or more steps and the main body may then have one, two, three, four or more steps and in some embodiments may have as many as eight, ten or more steps allowing for use with both smaller and larger boats. The combination bracket(s) for mounting the ladder assembly are also variable and can be used with trailers of various sizes and configurations.

In the illustrative embodiment of the figures, a ladder assembly 10 comprises a first ladder portion 12 and a stair extension 14 that are rotatably connected at a connection point 16.

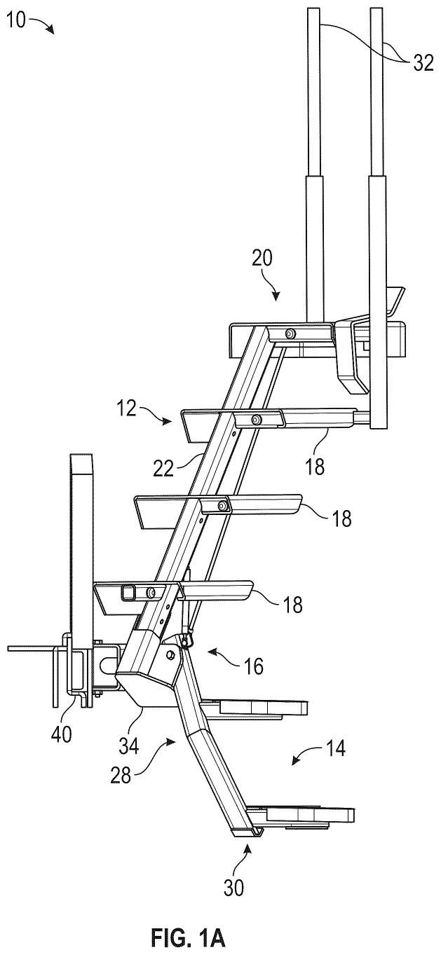

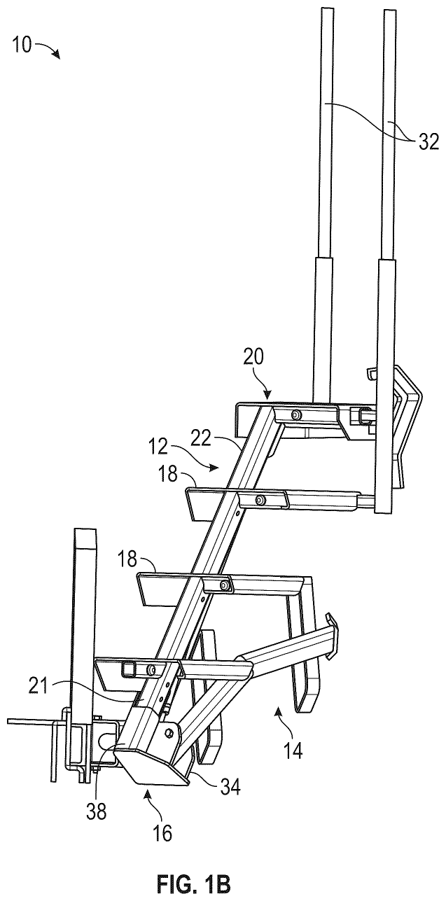

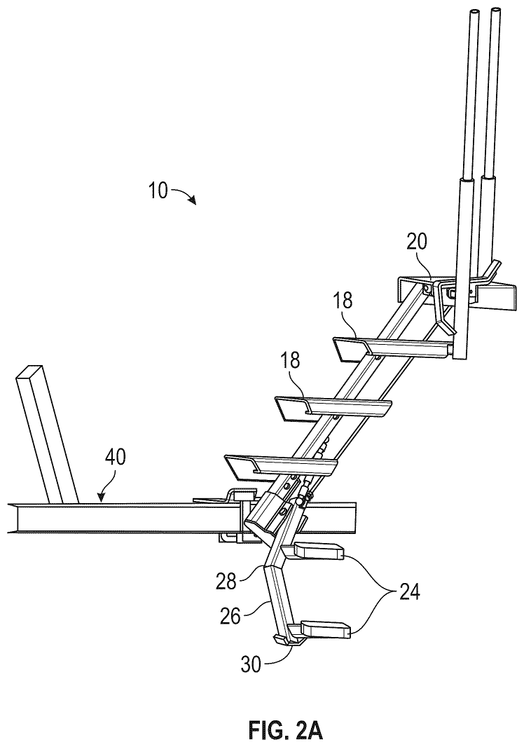

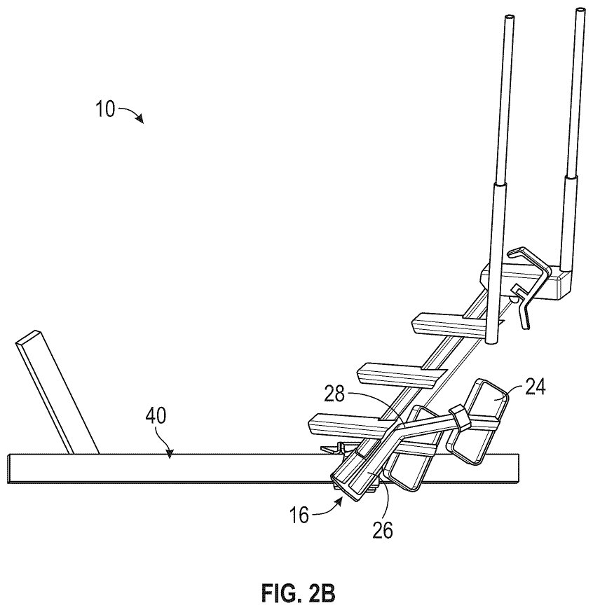

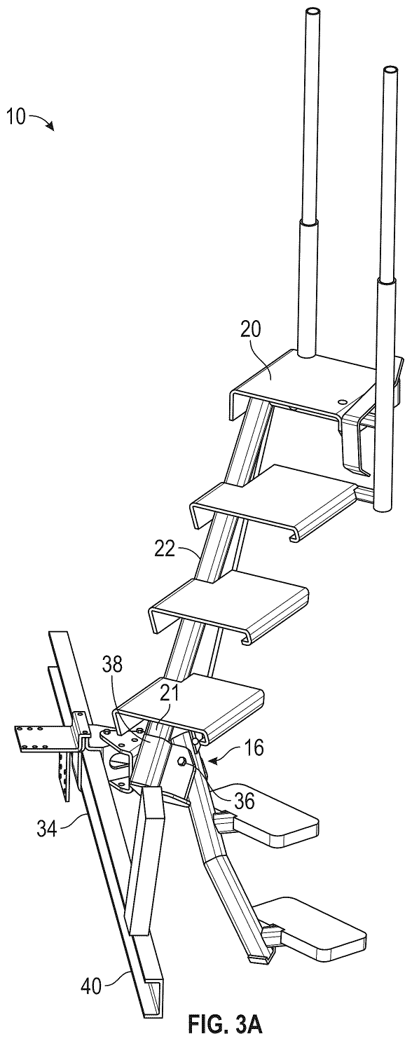

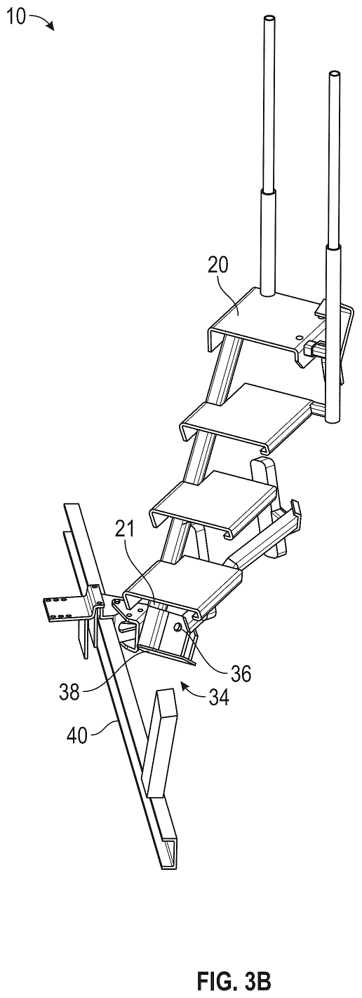

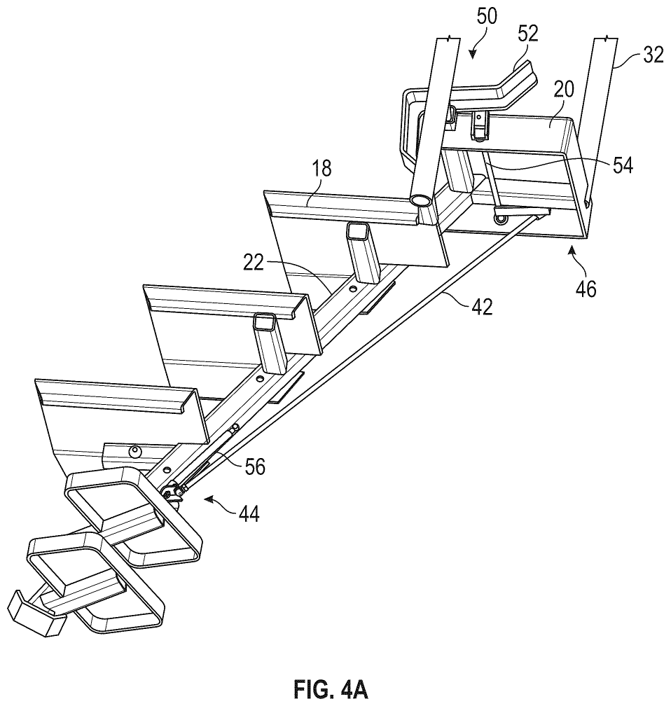

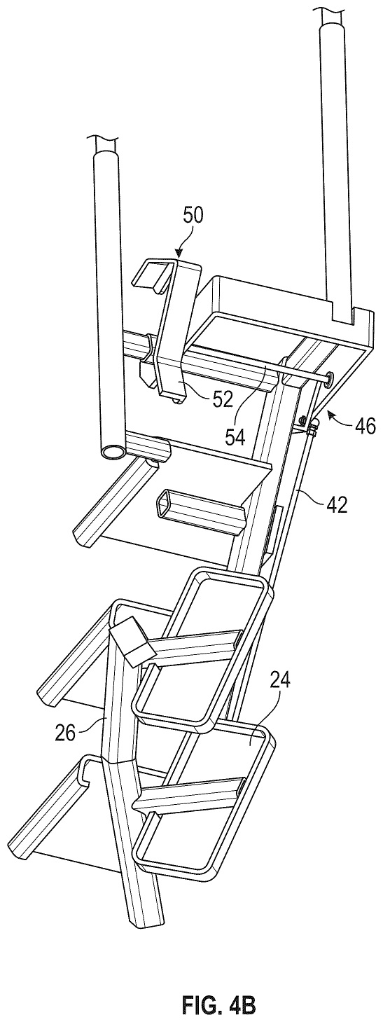

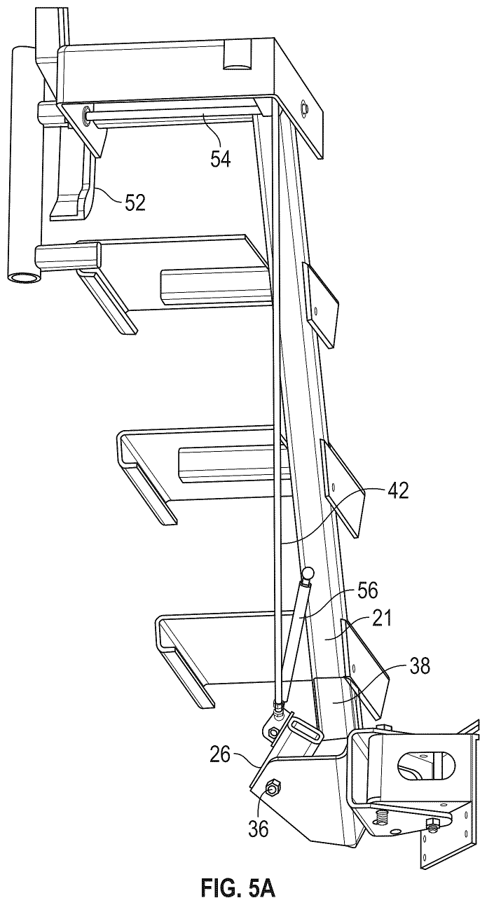

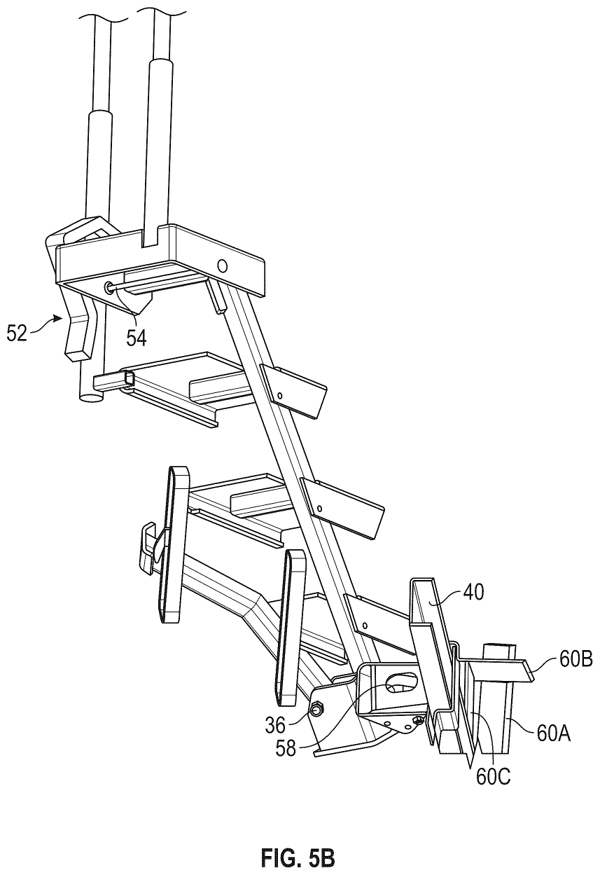

Referring to FIGS. 1A-5B, the first ladder portion 12 has a plurality of stairs 18 and an upper platform 20. A framework 22 may be a support leg and provides mounting support for the stairs 18 of the first ladder portion 12. The first ladder portion 12 may also support one or more vertically oriented hand rails 32 extending from one or more locations on the first ladder portion. The hand rails 32 are adjustable and may be telescoping hand rails such that a height of the hand rails 32 can be adjusted manually and secured at a selected height. The hand rails 32 can be stowed in a lower position as well.

The stair extension 14 is a second ladder portion of the ladder assembly 10 and similarly supports at least one stair 24. A framework 26 may be a support leg and provides mounting support for the at least one stair 24 pf the stair extension 14. In the embodiment illustrated, the framework 26 is non-linear and comprises at least one bend 28 along the length thereof. The stair extension 14 also terminates in a foot pad 30 which is coupled to the framework 26.

The first ladder portion 12 and the stair extension 14 are rotatably connected, such that the stair extension 14 is operably coupled to the first ladder portion 12 in a manner that allows the stair extension 14 to rotate about the connection point 16 in reciprocal directions. The connection point as illustrated comprises a bracket assembly 34 wherein the stair extension is rotatably connected to the bracket assembly 34 by way of a pin, bolt, or other fastener 36 allowing for rotation extending from a first surface of the bracket assembly 34 through apertures in the framework 26 and to a second opposing surface in the bracket assembly 34.

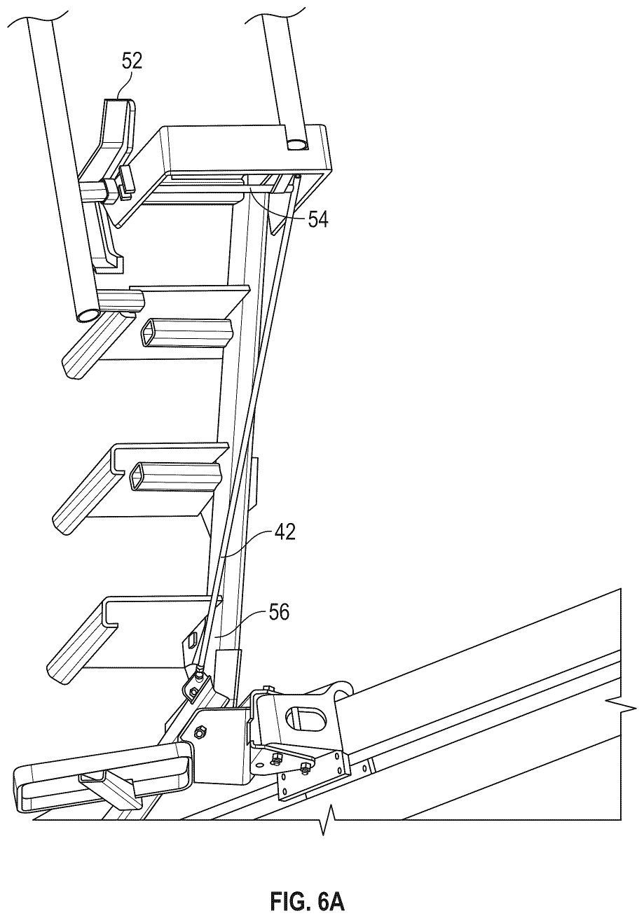

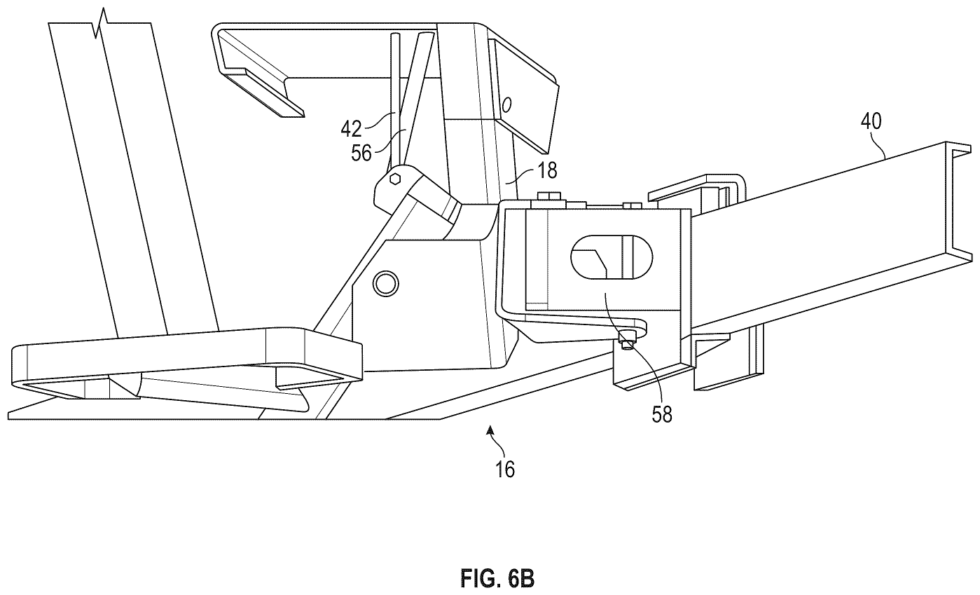

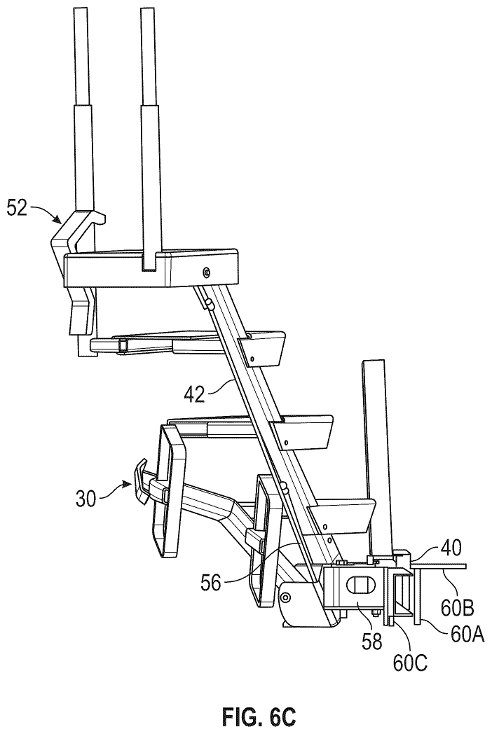

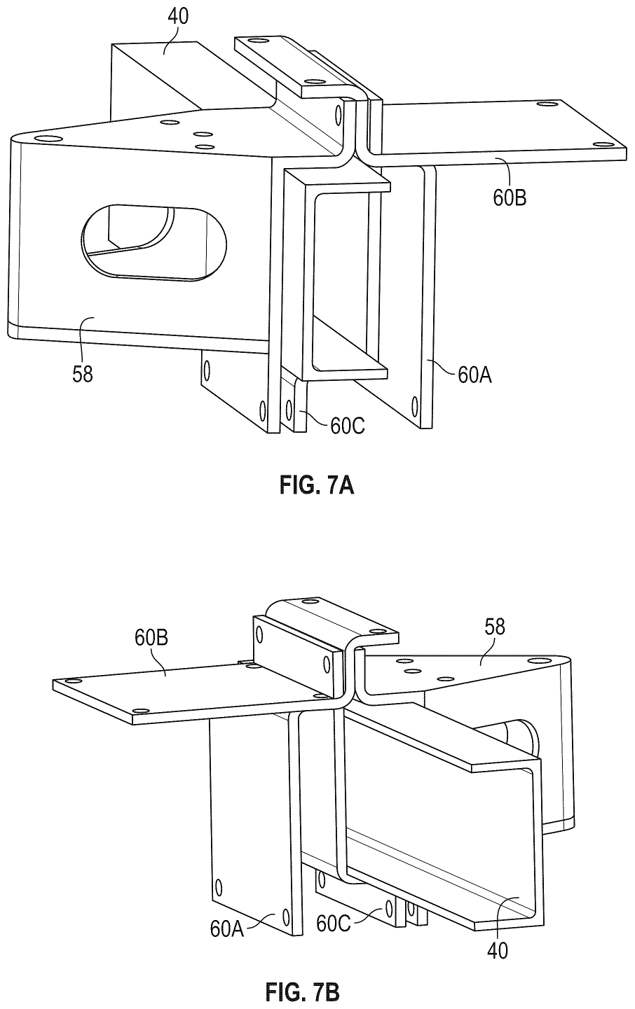

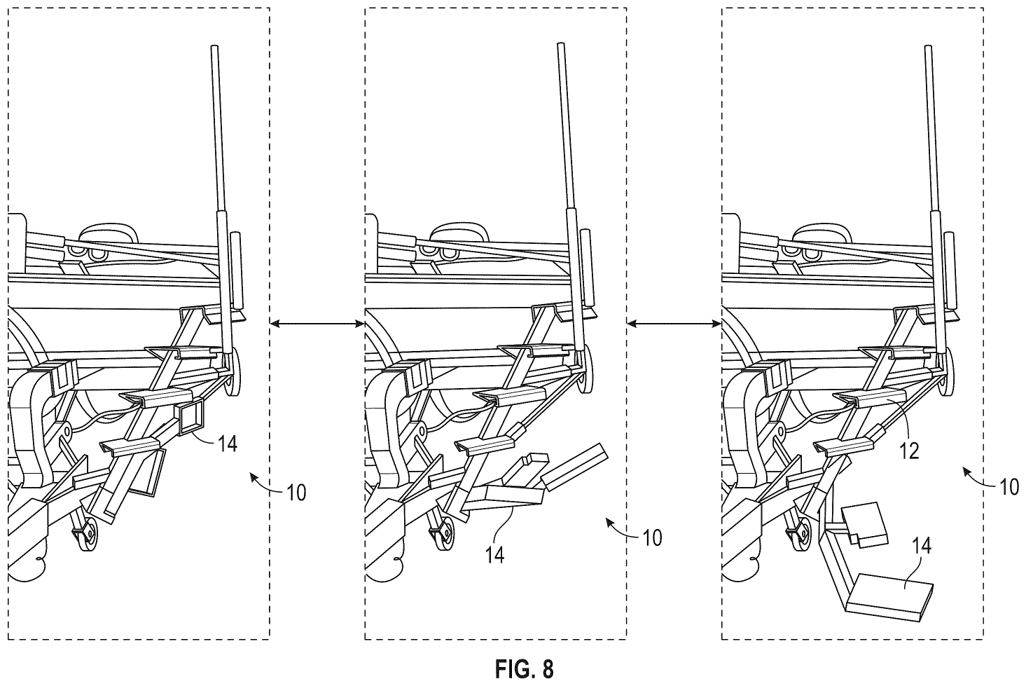

The bracket assembly 34 further comprises a mechanism for stationarily coupling the bracket assembly 34 to the first ladder portion 12. In the embodiment illustrated, a lower end 21 of the framework 22 is received in a cavity 38 in the bracket assembly 34 and secured thereto. A retractable pin and aperture mechanism cooperating on the frame work 22 and bracket 34 may also for adjusting a height of the first ladder portion 12 with respect to connection to the stair extension 14 at the connection point 16. Alternatively, the bracket assembly 34 may be clamped on two or more sides of the framework 22 or otherwise stationarily secured or welded to the bracket assembly 34. The connection point 16 is an assembly that allows for the operable connection of the first ladder portion 12 to the stair extension 14 and may further support concurrently the mounting of the ladder assembly 10 to a boat trailer 40 at that same point 16 or approximately thereabouts. As illustrated in FIGS. 6A-7B, the connection point 16 may further be provided with a mechanism 58 for coupling the bracket assembly 34 to or around a location on the trailer via coupling with additional brackets 60A, 60B, 60C, where one or more of the additional brackets 60A, 60B, or 60C are used depending on the size of the trailer and which may effectively clamp the assembly 10 to the trailer 40.

The connection of the first ladder portion 12 and the stair extension 14 further provided with one or more mechanisms to effect controlled rotation of the stair extension 14 and thus the transition of the ladder assembly 10 between a first, extended position with the stair extension 14 deployed and a second, stowed position with the stair extension 14 retracted and stowed upwardly and at least partially behind the first ladder portion 12. The one or more mechanisms comprises an air cylinder or a gas shock 56 which is operably connected between the framework 22 of the first ladder portion 12 and the framework 26 of the stair extension to aid in the rotation of the stair extension 14 about the connection point with the first ladder portion 12. The one or more mechanisms may further comprise a support rod 42 which extends from a first connection point 44 on an upper portion of the stair extension 14 framework 26 at a location bear the rotation point for the stair extension 14 to connection with the first ladder portion 12. The support rod 42 couples to an actuation mechanism 50 for stair extension deployment at a second connection point 46. The second connection point 46 is supported at the actuation mechanism 50 location, which in the embodiment illustrated is provided at an upper end of the ladder assembly 10, at the platform 20.

The actuation mechanism 50 comprises a surface, such as a lever 52 for manually actuating the deployment and stowing of the stair extension via initiating rotation of the stair extension 14 about the connection with the first ladder portion 12. The lever 52 is moved to rotate a cross bar 54 which is operably connected to the support rod 42 and thus transfers the movement of the lever 52 to reciprocal linear movement, for example, vertical movement, of the support rod 42 which in turn provides a pulling or pushing force on the stair extension 14, which is sufficient to activate the air cylinder or gas shock 56. Together, the gas shock 56 and the support rod 42 provide motive force for pulling or pushing the stair extension 14 such that the framework 26 rotates about the connection pin at the connection point 16.

The lever 52 is positioned adjacent the platform such that a user climbing the ladder assembly may use their foot to move the lever 52 when at or near the top of the first ladder portion 12 to either deploy or retract the stair extension 14 depending on whether they are climbing up or down the ladder. The lever 52 has a surface that extends allowing a user to also use their hand to access the lever 52 from inside the boat in the event the user, for example, forgets to stow the stairs before entering the boat.

The foot pad 30 may also act as an actuator for automatic stowing of a deployed stair extension 14. When force is applied to the foot pad 30 from any side or direction, upward rotation and stowing of the stair extension is initiated as the force is sufficient to activate the gas shock 54 which pulls the stair extension 14 upwardly via the framework 26. In the embodiment illustrated the air cylinder or gas shock 54 operably couples the respective frameworks 22 and 26 of the ladder assembly 10 and is force actuated, such that deployment of the stair extension is carried out with an extension stroke of the air cylinder as the actuation of the release of the actuation mechanism 50 allows compressed air to enter a cap-end port and push a piston forward, extending the piston rod. Retraction of the piston then supports stowing of the stair extension 14.

The one or more embodiments and functions of the ladder described herein are incorporated into a ladder having platforms for climbing and may be incorporated into open ladders and other ladder construction having flat steps or pads with or without side rails and with or without handrail(s) and further incorporated into a ladder of general construction having handrails and steps extending therebetween.

Although the present disclosure has been described with reference to preferred embodiments, workers skilled in the art will recognize that changes may be made in form and detail without departing from the spirit and scope of the disclosure.

1. A ladder assembly for mounting to a boat trailer comprising:
a stationary ladder section comprising a plurality of steps; and
a stair extension portion comprising one or more steps, wherein the stair extension portion is rotatably coupled to the stationary ladder section;
a mechanism for actuation of automatic rotation of the stair extension portion for deploying and/or stowing the stair extension with respect to the stationary ladder section;
a boat trailer mounting assembly for coupling the ladder assembly to the boat trailer; and
a stair extension rotation control mechanism for controlling at least one of a speed and actuation of deploying or stowing of the stair extension portion.

2. The ladder assembly of claim 1 where in the ladder assembly is moveable between a first position wherein the stair extension is deployed for use and a second position wherein the stair extension is stowed and when stowed the stair extension does not obstruct an entrance to the stationary ladder section.

3. The ladder assembly of claim 2 wherein in the first position the stair extension is deployed and is positioned below and to a side of the stationary ladder section.

4. The ladder assembly of claim 1 wherein the mechanism for actuation of automatic rotation of the stair extension portion is provided on an upper portion of the stationary ladder section accessible from both a position on the ladder assembly and off the ladder assembly.

5. The ladder assembly of claim 4 and further comprising a second mechanism for actuation of the rotation of the stair extension portion is provided on a lower portion of the stair extension wherein the first and second mechanisms apply force to the stair extension rotation control mechanism for actuation thereof.

6. The ladder assembly of claim 1 wherein the ladder framework further comprises a lighting system for illuminating one or more steps of the assembly.

7. The ladder assembly of claim 1 wherein the stair extension rotation control mechanism comprises an air cylinder operably coupled between the stationary ladder section and the stair extension portion.

8. The ladder assembly of claim 1 and further comprising a connection bracket which couples a framework of the stationary ladder section to a framework of the stair extension portion, the connection bracket stationarily secured to the framework of the stationary ladder section and the stair extension rotatably coupled to the connection bracket.

9. The ladder assembly of claim 8 wherein the connection bracket is also coupled to the boat trailer mounting assembly which comprises a bracket assembly that allows adjusting an angle and/or position of the ladder assembly with respect to the boat trailer when mounting the ladder assembly to the boat trailer.

10. The ladder assembly of claim 1 wherein the ladder framework further comprises a handrail.

11. The ladder assembly of claim 1 wherein stair extension portion comprises a support arm for the at least one step and wherein the support arm comprises at least one bend along a length thereof.

12. The ladder of claim 11 wherein the stair extension comprises at least two steps and the at least two steps are spaced apart by the at least one bend along the length of the support arm.

13. A method of using a ladder to enter a boat from a ground surface comprising:
securing a ladder assembly to a location on a boat trailer supporting the boat;
releasing a ladder extension mechanism to allow a ladder extension portion of the ladder assembly to rotate downwardly away from a main ladder body of the ladder assembly to expose additional steps of the ladder extension portion for climbing the ladder assembly; and
actuating the ladder extension mechanism to raise the ladder extension portion for stowing the ladder extension and providing ground clearance for moving the boat trailer without obstruction.

14. The method of claim 13 and further comprising positioning the ladder assembly with respect to the boat and boat trailer by adjusting an angular position of a mounting bracket for securing the ladder assembly to the location on the boat trailer.

15. The method of claim 13 wherein the ladder extension rotates downwardly to a side of the main ladder body such steps of the ladder extension extend vertically in a first direction and steps of the main ladder body extend vertically in a second direction different from the first direction.

16. The method of claim 13 and further comprising releasing the ladder extension mechanism and allowing the ladder extension portion of the ladder to rotate downwardly away from a main ladder body, from a position located at an upper end of the ladder assembly.

17. The method of claim 13 and further comprising actuating the ladder extension mechanism to raise the ladder extension portion from a position located at an upper end of the ladder assembly or from a position located at a lower end of the ladder assembly.

18. The method of claim 17 wherein a same mechanism is located at the upper end of the ladder assembly for alternately releasing the ladder extension mechanism and actuating the ladder extension mechanism for moving the ladder extension between a deployed and a stowed position via the same mechanism.

19. The method of claim 18 wherein a second, distinct mechanism is provided at the lower end of the ladder assembly for actuating the ladder extension mechanism to raise the ladder extension and wherein actuating the ladder extension comprises applying force to the second mechanism from one or more directions.
